(19) United States
(12) Patent Application Publication
(10) Pub. No.: US 2002/0159145 A1
(43) Pub. Date: Oct. 31, 2002

(54) Microscope with an illumination for a control element

(75) Inventor: Juergen Hoffmann, Bad-Camberg (DE)

Correspondence Address: SIMPSON & SIMPSON, PLLC, 5555 MAIN STREET, WILLIAMSVILLE, NY, 14221-5406, US

(73) Assignee: Leica Microsystems Heidelberg GmbH, Mannheim (DE)

(21) Appl. No.: 10/133,773

(22) Filed: Apr. 26, 2002

(30) Foreign Application Priority Data
Apr. 26, 2001 (DE) DE10120626.7

(51) Int. Cl. G02B 21/06

(52) U.S. Cl. 359/385

(57) ABSTRACT

Microscope (1) for investigating a sample having a light source (7), which emits illumination light (19) of at least one illumination wavelength for illumination the sample (15) and at least one control element (61 to 71). The microscope is characterized in that the control element (61 to 71) is visible in darkness.

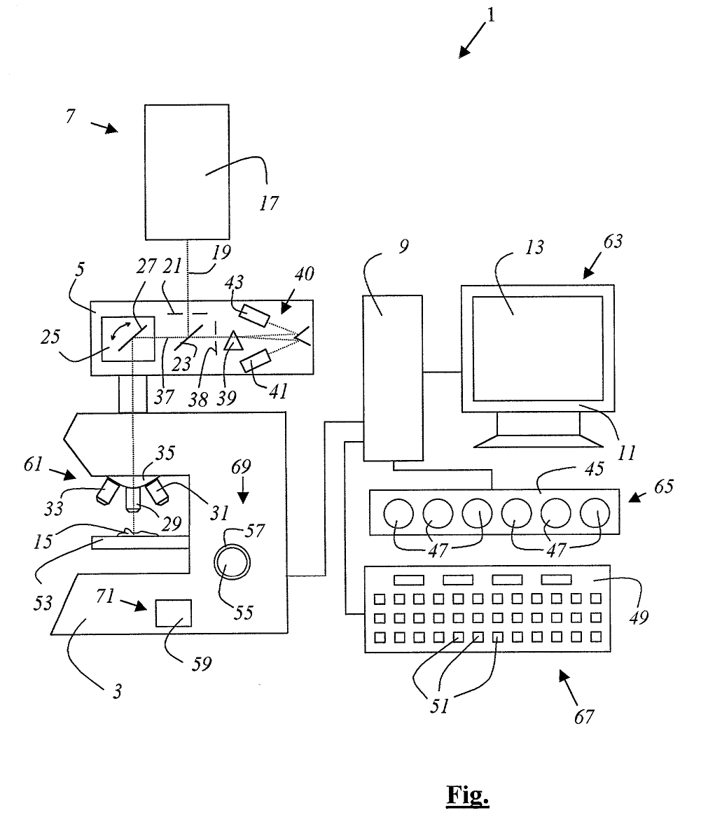

### CROSS REFERENCE TO RELATED APPLICATIONS

This application claims priority of the German patent application 101 20 626.7-42 which is incorporated by reference herein.

### FIELD OF THE INVENTION

The invention refers to a microscope and a scanning microscope for investigating a sample with a light source, which emits light of at least one illumination wavelength for illuminating the sample and at least one control element.

### BACKGROUND OF THE INVENTION

In microscopy, especially in the field of scanning microscopy, an illuminated sample is examined. In fluorescence microscopy and in fluorescence scanning microscopy a sample marked by specific fluorescence stains is illuminated with the light of one or several wavelengths to activate the sample and to detect the fluorescence light.

In scanning microscopy a sample is illuminated with a light beam to examine the detection light as a reflection or a fluorescence light. The detection light is emitted by the sample. The focus of an illumination beam is moved in a plane of the sample. This is done with the help of a controllable beam deflection device, generally by tilting two mirrors, wherein the deflection axes are located vertically on each other so that one mirror refracts in the direction of the x-axis and the other in the direction of the y-axis. The mirrors are often moved with the help of galvanometric set elements, for example. The power of the detection light emanating from the object is measured according to the position of the scanning beam. It is common practice to equip the set elements with sensors meant to measure the current mirror position. Especially in confocal scanning microscopy, the object is scanned in three dimensions with the focus of a light beam.

A confocal scanning microscope consists generally of a light source, focusing optics, which focuses the light of the source to a pinhole—the so-called illumination pinhole, a beam splitter, a beam deflection device to control the beam, microscope optics, a detection pinhole and the detectors to identify the detection or fluorescence light. The illumination light is coupled in via a beam splitter. The fluorescence reflection light emanating from the object returns to the beam splitter via the beam detection device to be then focused on the detection pinhole. The detectors are behind the pinhole. This detector arrangement is called a descan arrangement. Detection light that does not directly originate from the focus region takes another light path and does not pass the detection pinhole. This is how a point like information is retrieved. The point like information creates a three-dimensional image by scanning sequentially the object with the focus of the illumination beam. Most of the times the three-dimensional image is created by taking visual data in layers. Commercial scanning microscopes generally consist of a scanning module, which is flanged to the stand of a classical light microscope with the scanning module comprising all additional elements necessary for scanning the sample.

Commercial scanning microscopy comprises generally a microscope stand like the ones used in conventional light microscopy. As a rule especially confocal scanning microscopes can be used as conventional light microscopes. In conventional fluorescence light microscopy that part of the light of a light source (e.g. an arc lamp) that shows the desired wavelength for the illumination of fluorescence is coupled into the microscopic beam path with the help of a colour filter, the so-called illumination filter. The coupling into the beam path of the microscope is done with the help of a dichroitic beam splitter, which reflects the illumination light to the sample whereas it allows the fluorescence light emanating from the sample to pass mainly unhindered. The illumination light reflected by the sample is held back by a filter, which, however, lets the fluorescence illumination through.

In confocal scanning microscopy it is not necessary to use a detection pinhole in the case of a two photon illumination (or multiple photon illumination) since the exitation probability is dependent on the square of photon density and thereby on the square of the illumination intensity, which is naturally much higher in the focus region than in the neighbouring regions. The fluorescence light to be detected is therefore very likely to originate in large part from the focus region, which makes an additional differentiation of fluorescence photons between those from the focus region and those from the neighbouring region superfluous.

Regarding all the microscopes and microscopic methods mentioned it is necessary to illuminate the sample exclusively with light of the desired illumination wavelengths. If light of other wavelengths hits the sample then the sample is exited via undesired transitions and thereby undesired fluorescence light is caused. In addition it is disadvantageous if light of any other source hits the detectors of the scanning microscope directly, since light of another source cannot be distinguished from real detection light.

This is especially important in case of confocal scanning microscopes equipped with non-descan detection.

Another problem is on one hand to adapt the eyes to the darkness to be able to recognize even hardly illuminated details, whereas on the other hand the eyes are exposed to the ambient light when looking up from the eyepiece of the microscope.

To avoid that the sample is hit by undesired wavelengths and to avoid that light of any other source hits the detectors and to further achieve an adaptation of the eyes, the light in the room is turned off. This bears the disadvantage that the user does no longer see the control elements of the microscope. Especially in case of highly sophisticated microscopes, like confocal laser scanning microscopes for example, which have many control elements, it is impossible to darken the room totally since otherwise the microscope could not be properly used. This is why as a compromise the light in the room is just reduced. The elements of the microscope are often adjusted while the light in the room is turned on in order to then examine the sample when the light is dimmed. This method bears the disadvantage that the working parameters can no longer be modified during the examination.

### SUMMARY OF THE INVENTION

It is the object of the invention to provide a microscope, which overcomes the mentioned contradiction. The object is solved by a microscope, which comprises:

a light source defining an illumination source wherein the light source emits an illumination light of at least one illumination wave length for illumination the sample; and

at least one control element, which is visible in darkness by emitting light, wherein the emitted light has a wave length which is different to the illumination wave length.

It is a further object of the invention to provide a scanning microscope or a confocal scanning microscope, which overcomes the mentioned contradiction. The object is solved by a scanning microscope or a confocal scanning microscope, which comprises:

a light source defining an illumination source wherein the light source emits an illumination light of at least one illumination wave length for illumination the sample; and

at least one control element, which is visible in darkness by emitting light, wherein the emitted light has a wave length which is different to the illumination wave length.

The invention bears the following advantage: Especially in case of fluorescent samples that emit only few fluorescence photons, incorrect examination and test results caused by unintended direct illumination through the ambient light or by ambient light hitting the detectors directly, are avoided. In addition the invention bears the advantage that the eyes do not have to go through the tiring, repetitive and time-consuming adaptation process.

In a preferred embodiment the control elements of the microscope are self-radiant. They are made of a luminescending material, for example. In another embodiment the control elements are covered totally or partially with a luminescending, fluorescending or phosphorizing material, as it is known from wristwatch faces.

In a further embodiment the microscope is equipped with a control element illumination that only illuminates those control elements necessary for the operation.

In an especially preferred embodiment the control elements are equipped with an integrated background illumination, as known from hifi systems, for example. Preferably this background illumination can be turned off and its light intensity can be modified both manually and automatically. In the case of scanning microscopes, the switching off is done automatically in one kind of embodiment namely when starting the scanning process. At the end of a scanning process the switching on starts automatically. Furthermore, the microscope is planned to be equipped with the possibility to darken the screen automatically or to dim the light in the room.

Control elements are for example: Control knobs and touch pads for adjusting the focus, the objective revolver, displacement device of the stage, the display of the table position, filter wheels or the corresponding set apparatus, the control elements of the sample illumination, the keyboard, the mouse and the screen or the display of the control computer, elements to adjust the detector gain (e.g. a rotating potentiometer).

Preferably the illuminated control elements reflect light of a spectral composition which is neither relevant for sample illumination or detection, i.e., which is far out of the wavelengths spectrums of illumination and detection. Band pass filters are arranged in front of the detectors. The filters do not transmit light of the wavelengths of control element illumination or control elements. In addition the light used does not have to be visible light, if aids are used for visualization purposes. Standard CCD cameras that are generally also sensitive in the IR range and the image of which can be transmitted to video glasses for example can be used as aids.

### BRIEF DESCRIPTION OF THE DRAWINGS

In the drawing the invention is schematically shown and is described with respect to the single figure. It shows:

FIGURE a confocal scanning microscope with illuminated control elements

### DETAILED DESCRIPTION OF THE INVENTION

The only drawing shows a microscope 1, which is designed as a confocal scanning microscope. The microscope 1 is equipped with a microscope stand 3, a scanner 5, a light source 7 and six control elements 61 to 71, such as a revolver 35, a monitor 11, a panelbox 57, a keyboard 59, a set knob 55 and a back lighted LCD display 59. The functions of the control elements 61 to 71 and their embodiments are described as follows: Computer 9 controls the microscope. Computer 9 is connected to the monitor 11, which serves on one hand to depict the image 13 of the sample 15 and on the other hand to display the microscope parameters. The light for sample illumination emanating from the light source 7, which is designed as a laser 17 here, shows a wavelength of about 800 nm and is focused on an illumination pinhole 21 via optics that are not illustrated here.

The light is then reflected by a beam splitter 23 to a beam deflection device 25, which comprises a cardanic mounted mirror 27. The light for sample illumination 19 shaped as a beam is transmitted via a scanning optic and a eyepiece optic, which are both not illustrated, and via the objective 29 to the sample 15. The objective 29 is nested in the revolver 35 together with additional objectives 31,33. The revolver 35 has a phosphorizing cover, which makes the revolver visible in the dark and makes the change of objectives possible. In addition the objective revolver 35 shows phosphorizing marks that are both visible in the dark and clarify which objective is currently placed in the beam path. The detection light 37 emanating from the sample passes through the objective 29 and through the beam deflection device 25 back to the beam splitter 23. The light passes the beam splitter 23 and the detection pinhole 38 and hits the prisma 39 of the multi-band detector 40. The prisma 39 spatially splits the light for the multi-band detector 40 which comprises the two detectors 41 and 43. The detectors 41, 43 are designed as photomultipliers. The system parameter, like the amplifier voltage of the detectors 41, 43, the maximum reflection angles of the beam deflection device 25 and the focussing of the detection bands of multi-band detectors 39 are arranged with the help of a panel box 45 and a keyboard 49. The panel box 45 has six illuminated control knobs 47, which can be individually switched on. The keyboard 49 has back lighted keys 51. The control knobs 47 are equipped with a light emitting diode (not illustrated here), the light of which shines through the half-transparent plastic material of the control knobs 47. The keyboard 49 is equipped with many light bulbs that serve as a back light illumination. The keys 51 are equipped in such a way that the light, which is shining through, makes it possible to recognize the functions of the keys. The material of the keys is therefore of a different thickness showing different characteristics regarding colour and transparency.

With the help of a set knob 55 it is possible to move the stage 53 on which the sample is positioned 15 in a vertical direction for focussing purposes. The set knob 55 has a phosphorizing ring 57, which makes it possible to see the position of the set knob 55 in the dark. The back lighted LCD display is meant to show the current position of the focus.

The invention was described with respect to a specific embodiment. It is obvious that changes and alterations can be made without leaving the scope of protection of the claims below.

What is claimed is:

1. A microscope for investigating a sample comprises:
a light source defining an illumination source wherein the light source emits an illumination light of at least one illumination wave length for illumination the sample;
and at least one control element, which is visible in darkness by emitting light, wherein the emitted light has a wave length which is different to the illumination wave length.

2. Microscope as defined in claim 1, wherein the control element is self shining.

3. Microscope as defined in claim 1, wherein the control element is showing luminescence.

4. Microscope as defined in claim 1, wherein an illumination for the control element is provided.

5. Microscope as defined in claim 4, wherein the illumination is a back lightning.

6. Microscope as defined in claim 1, wherein the power of the light emitted from the control element is variable.

7. A scanning microscope or a confocal scanning microscope for investigating a sample comprises:
a light source defining an illumination source wherein the light source emits an illumination light of at least one illumination wave length for illumination the sample; and
at least one control element, which is visible in darkness by emitting light, wherein the emitted light has a wave length which is different to the illumination wave length.

8. Scanning microscope as defined in claim 7, wherein the light level of the illumination of the control element of the light emanating from the control element is automatically controllable.

9. Scanning microscope as defined in claim 8, wherein the illumination of the control element is automatically switched off during the scan of the sample.

10. Scanning microscope as defined in claim 7 wherein the light level of the illumination of the back lightning of the control element is automatically controllable.

11. Scanning microscope as defined in claim 10, wherein the back lightning of the control element is automatically switched of during the scan of the sample.
